(19) United States
(12) Patent Application Publication
(10) Pub. No.: US 2023/0185245 A1
(43) Pub. Date: Jun. 15, 2023

(54) Time system clock face and method 364 degree for determining the time of the day

(71) Applicants: Vladimir P. Kulikov, Marina Del Rey, CA (US); Yelena A. Kulikova, Marina Del Rey, CA (US)

(72) Inventors: Vladimir P. Kulikov, Marina Del Rey, CA (US); Yelena A. Kulikova, Marina Del Rey, CA (US)

(21) Appl. No.: 17/989,004

(22) Filed: Nov. 17, 2022

Related U.S. Application Data
(63) Continuation-in-part of application No. 16/529,048, filed on Aug. 1, 2019, now abandoned.

(51) Int. Cl. G04B 19/08

(52) U.S. Cl. CPC G04B 19/085

(57) ABSTRACT

The 364 degree method for selecting a new degree value, as the unit of rotation and the new times calculations. The new times system clock. The new time system clock face has multiple time scales (hours, minutes and seconds) one of which is driven by the clock drives in cooperation with an hour indicator (e.g., an hour hand).

### FIELD OF THE INVENTION

The present invention relates generally to new calculation of the time. The new time system clock and instruction. The 364 degree method for selecting a new degree value as the unit of rotation and angle.

### BACKGROUND OF THE INVENTION

One theory states that time is related to the fact that 360 is approximately the number of days in a year. Ancient astronomers noticed that the sun, which follows through the ecliptic path over the course of the year, seems to advance in its path by approximately one degree each day. Some ancient calendars, such as the Persian calendar, used 360 days for a year. The use of a calendar with 360 days may be related to the use of sexagesimal numbers.

Another theory is that the Babylonians subdivided the circle using the angle of an equilateral triangle as the basic unit and further subdivided the latter into 60 parts following their sexagesimal numeric system. The earliest trigonometry, used by the Babylonian astronomers and their Greek successors, was based on chords of a circle. A chord of length equal to the radius made a natural base quantity. One sixtieth of this, using their standard sexagesimal divisions, was a degree. A circle with an equilateral chord. One sixtieth of arc is a degree. Six such chords complete the circle.

Alternatively, the traditional sexagesimal unit subdivisions can be used. One degree is divided into 60 minutes (of arc), and one minute into 60 seconds (of arc). Use of degrees-minutes-seconds is also called DMS notation. Very early in modern history, people began marking time so that they could mark the change of the seasons, the ebb and flow of the tides, and, generally, the time of day. Such marking was done by way of the sundial, which made use of the natural cyclic rotation of the Earth. Later, the sundial was modified to take the form of a clock face, but retained the cyclical nature of the sundial.

Aristarchus of Samos and Hipparchus, apparently, were among the first Greek scientists who systematically used Babylonian astronomical knowledge and methods. Timocharis, Aristarchus, Aristillus, Archimedes and Hipparchus were the first known Greeks to divide a circle into 360 degrees of 60 arc minutes, 1 minute=360/60=6 degrees. Eratosthenes used a simpler sexagesimal system of dividing a circle into 60 parts. The division of the circle into 360 parts also took place in ancient India, as evidenced by the Rig Veda.

There does not appear to be a teaching method and system that adequately and conveniently addresses teaching and understanding of the cyclical nature of time, from hour-to-hour, daytime-to-nighttime, day-to-day, and the like. Nor does there appear to be a teaching method and system that adequately, conveniently, and holistically addresses the concepts of time.

The current popular global time convention that is based upon Sun-angles relative to an extend flat earth surface can have the effect of limiting our conception of time. In observing a sunset, say, one can muse upon the basic thought that the Sun is setting, bringing an end to the light of day, whereas a multidimensional concept of time can emphasize an awareness that while locally observing a sunset, the Sun is simultaneously shining straight overhead a different section of the globe.

### BRIEF SUMMARY OF THE INVENTION

The present invention enables time to be read directly from the clock display, 13-hour half day or 364 degree rotation of the hand hour, 26-hour full day or 728 degree rotation of the hand hour, and digital clock embodiments all use the present time.

The new time system clock and method 364 degree for determining the time of day, including the clock display representing an entire day. The clock display preferably has sections corresponding to natural divisions of the day, such as AM and PM, as well as further divisions for facilitating, such as hourly divisions, half-hourly divisions, or the like.

The present invention comprising clock display having a 364 degree closed-loop path, an hour (minute, second) hands of the clock. The an hour hand of clock proceeds through full rotations around the dial the 13 hours of half day and proceeds through two full rotations around the dial the 26 hours of full day, i.e. 728 degree of rotation, it preferably marks out the entire day 26 hours of a day.

### BRIEF DESCRIPTION OF THE DRAWING(S)

FIG. 1 is a graphical representation of a clock face divided into 13-hours, a graphical representation of a 13-hour clock face. The 13-hour analog clock face associated with the 13-hours of the half-day. The new time system clock face has multiple time scales (hours, minutes, seconds) one of which is driven by the clock drives in cooperation with an hour indicator (e.g., an hour hand).

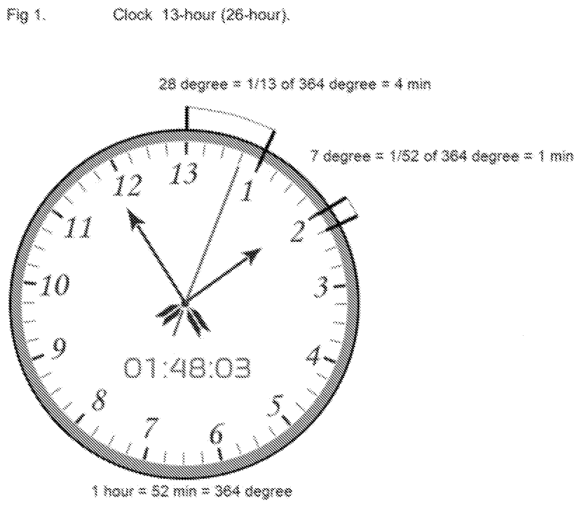

The clock face is in orientation with local noon at the top. The driven display components are the hour hand which rotates clockwise once every 13 hours (half day) and rotates twice every 26 hours (full day), the minute hand which rotates clockwise once every 52 minutes (one hour) and the second hand which rotates clockwise once every 52 second (one minute).

The time clock system contain a digital 26 or 13 AM/PM hour display driver and the indicators are displays digitally by the timer driver.

### DETAILED DESCRIPTION OF THE INVENTION

The present invention is a novel time standard that is usable at substantially all geographic locations.

The present time standard is based on a system that tracks the Sun's position with respect to the Earth. The time of the present invention is specified by the position of the mean sunn with respect to the Earth. The mean sunn, defined herein as the “sunn”, is a Sun construct that has uniform motion that is synchronized to the uniform motion of a clock's hour hand (the difference between the motion of the sunn and the apparent motion of the Sun as observed from a point on the Earth's surface). Time is organized in the present invention by marking the passage of the sunn over longitude lines that are divided into 14 degree (new value of the degree) with the Earth sectioned into 26 equal time zones corresponding to the 26 hours (new value of hour) of a day, equating to the 364 degree rotation in each day (with respect to the sunn) with each hour divided into 52 equal minutes (new value of minute) and each minute divided into 52 equal seconds (new value of second), so that standard of the present invention incorporates conventional local time standards with reduced effort in translation between the two.

The 364 degree method for selecting a new degree value as the unit of rotation and angles defined so that the total rotation is 364 degrees (new degree value), 52 arc minutes (new minute value), 52 arc seconds (new second value).

The new system time clock. The clock face is divided into 364 parts equal to 364 degrees (the new value of the degree). New system clock and new time standard (13 (AM/PM)—hour analog time display (dial) or digital clock 13 (AM/PM)—hour or 26-hour display), one hour equal to 364 degrees rotation of the hand minute (new degree value), one minute equal to 364/52 equal to 7 degrees or 364 degree rotation of the hand second (new degree value), one second equal to 364/52 equal to 7 degrees (new degree value), one hour equal to 52 minutes or 364 degrees rotation of the hand minute (new value of hour), one minute equal to 52 second or 364 degree rotation of the hand second (new value of minute).

1. The time system clock face comprising: the timer drivers operating the components of the time system clock face, having combination analogue and digital clock face, the time indicating means including an hour indicating means, a minute indicating means, a second indicating means.

2. The time clock face system of claim 1, wherein the timers drivers further comprises means for driving the hours indicator, the minutes indicator, the seconds indicator, the indicators are displayed analogue and digitally by the timers drivers.

3. The time clock face system of claim 2, wherein the timers drivers comprise a clock motor and the indicators are rotatable by the timers drivers.

4. The time clock face system according to claim 1, in which the timer driver contain a digital 26 or 13 AM/PM hours display driver and the indicators are displayed digitally by the timer driver.

5. The time system clock face of claim 2 comprising: the time system clock face has hour of a 13-hour time scale, combination with an hour hand driven by the timer hours driver, and a 52 minutes time scale in combination with a minutes hand driven by the timer minute driver, and a 52 seconds time scale in combination with a seconds hand driven by the timer seconds driver.

6. A method of teaching time comprising the steps of: relating hour, minute, second of a day comprising closed-loop path of the time system clock face defining rotation of the hand hour, hand minute, hand second on 364 parts, and further comprising the step of: relating 364 parts to 364 degrees, the degree indicating means new value of the degree around a center of clock face.

7. The method of claim 6, further comprising the steps of: relating 364 degree of the defining rotation of the hand hour around a center of clock face 13 hours time scale of half day; and further comprising the steps of: relating a second 364 degree rotation defining 728 degree rotation of the hand hour around a center of clock face 26 hours time scale of full day and the hour indicating means new value of hour.

8. The method of claim 6, further comprising the steps of: relating 364 degree of the defining rotation of the hand minute around a center of clock face 1 hour (52 minute) time scale and the minute indicating means new value of minute.

9. The method of claim 6, further comprising the steps of: relating 364 degree of the defining rotation of the hand second around a center of clock face 1 minute (52 seconds) time scale and the second indicating means new value of second.

10. The method of claim 7, further comprising the steps of: relating the 1 hour is indicating means 28 degree section of clock face.

11. The method of claim 8, relating the 1 minute is indicating means 7 degree section of clock face.

12. The method of claim 9, relating the 1 second is indicating means 7 degree section of clock face.
